(19) United States
(12) Patent Application Publication
(10) Pub. No.: US 2025/0357687 A1
(43) Pub. Date: Nov. 20, 2025

(54) Electrical Connector

(71) Applicant: Tyco Electronics (Shanghai) Co., Ltd., Shanghai (CN)

(72) Inventors: Wenfang (Felix) Zhang, Shanghai (CN); Yongjian (Justin) Huang, Shanghai (CN); Tongbao (Tim) Ding, Shanghai (CN); Qin (Candy) Xu, Shanghai (CN); Weijie (Warren) Huo, Shanghai (CN)

(73) Assignee: Tyco Electronics (Shanghai) Co., Ltd., Shanghai (CN)

(21) Appl. No.: 19/210,431

(22) Filed: May 16, 2025

(30) Foreign Application Priority Data
May 17, 2024 (CN) 202410620521.0

(51) Int. Cl. H01R 11/11; H01R 13/426; H01R 13/502; H01R 13/58

(52) U.S. Cl. CPC H01R 11/11; H01R 13/426; H01R 13/502; H01R 13/582

(57) ABSTRACT

An electrical connector includes a terminal having an end connecting to a cable, a terminal position assurance member having a terminal fixing portion fixedly connecting to the terminal, and a housing. The terminal is mounted to the housing together with the terminal position assurance member.

### CROSS-REFERENCE TO RELATED APPLICATIONS

This application claims the benefit of the filing date under 35 U.S.C. § 119 (a)-(d) of Chinese Patent Application No. 202410620521.0, filed on May 17, 2024.

### FIELD OF THE INVENTION

The present disclosure relates to the field of electronic connection accessories and, more particularly, to a new type of electrical connector.

### BACKGROUND OF THE INVENTION

Electrical connectors are indispensable electronic components of various electrical and electronic systems. They are widely used in aerospace, aviation, nuclear industry, weapons, ships, electronics, transportation, computers, communications, medicine, oil exploration and other industries. Electrical connectors are mainly used for circuit connections between cables of electrical and electronic devices, as well as between cables and devices, so as to realize transmission of low-frequency signals, high-frequency signals, and electric energy (power).

However, in the assembly process of some prior electrical connectors, the insertion of terminals and/or cables is difficult and the operation is complicated, which not only affects the working efficiency but also may cause damage to cables or terminals. Especially for the electrical connector with a small wire diameter cable, the cable is more likely to be deformed during the assembly process of inserting the terminal into the housing, the insertion of the terminal is difficult, the production cost of the product is high, and it is difficult to realize automatic assembly.

FIG. 1 is a schematic diagram of an electrical connector 100 in the prior art. The electrical connector 100 includes a connector body 110, a terminal 120, and a wire 130. A plurality of insertion slots are arranged side by side on the connector body 110, and each insertion slot receives a terminal 120, where one end of the terminal 120 protrudes from the bottom of the insertion slot, the other end of the terminal 120 is connected with a wire 130.

During the assembly process of the electrical connector 100, it is difficult to find a suitable operation position to realize automatic assembly when the terminal 120 and the wire 130 are inserted into the insertion slot, and the wire 130 may be deformed during the insertion process. Especially when the wire 130 is a small wire diameter cable or a soft cable, the insertion is more difficult, the production cost of the product is high, and the production efficiency is low.

### SUMMARY OF THE INVENTION

An electrical connector includes a terminal having an end connecting to a cable, a terminal position assurance member having a terminal fixing portion fixedly connecting to the terminal, and a housing. The terminal is mounted to the housing together with the terminal position assurance member.

### BRIEF DESCRIPTION OF THE DRAWINGS

Features, advantages, and other aspects of the present disclosure will be readily understood through the following detailed description with reference to the accompanying drawings, in which several embodiments of the present disclosure are shown by way of example and not limitation. In the drawings:

FIG. 1 shows a schematic diagram of an electrical connector in the prior art;

FIG. 2a shows a schematic diagram of an electrical connector according to an embodiment of the present disclosure;

FIG. 2b shows a schematic diagram of an assembly process of the electrical connector shown in FIG. 2a;

FIG. 2c shows an enlarged schematic diagram of a region E in FIG. 2b;

FIG. 2d shows an enlarged schematic diagram of a region F in FIG. 2b; and

FIG. 2e shows a schematic diagram of an internal structure of the electrical connector after assembly.

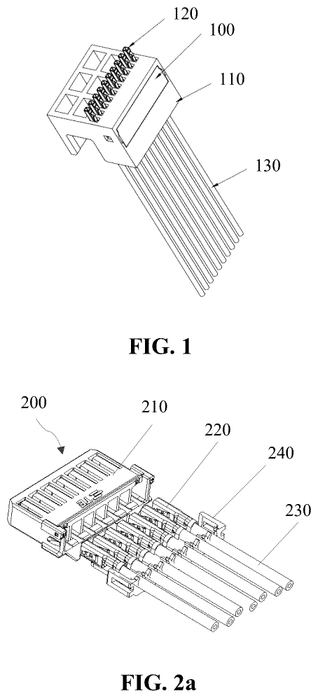

### DETAILED DESCRIPTION

The following detailed description of the embodiments refers to the accompanying drawings that form a part of the present disclosure. The drawings show, by way of illustration, specific embodiments in which the disclosure can be practiced. The exemplary embodiments are not intended to be exhaustive of all embodiments of the present disclosure. In the specification, the same or similar reference numerals indicate the same or similar components. It is to be understood that other embodiments may be utilized and structural modifications may be made without departing from the scope of the present disclosure. The following detailed description, therefore, is not to be taken in a limiting sense, and the scope of the present disclosure is defined by the appended claims.

The terms “including”, “comprising” and similar terms used herein should be understood as open-ended terms, i.e., “including/comprising but not limited to”, indicating that other elements may be included. The term “one embodiment” denotes “at least one embodiment”; the term “another embodiment” denotes “at least one additional embodiment”, and so on.

As mentioned above, the existing electrical connectors have technical defects of difficult realization of automatic assembly and easy deformation of cables in the assembly process, and in order to solve or improve at least one portion of the technical problems, the present disclosure provides an electrical connector with a novel structure. The present disclosure is described in detail below with reference to the accompanying drawings and embodiments.

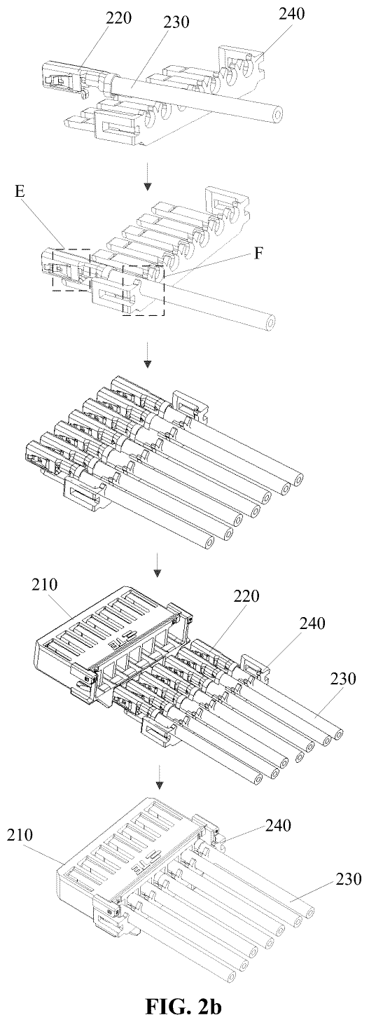

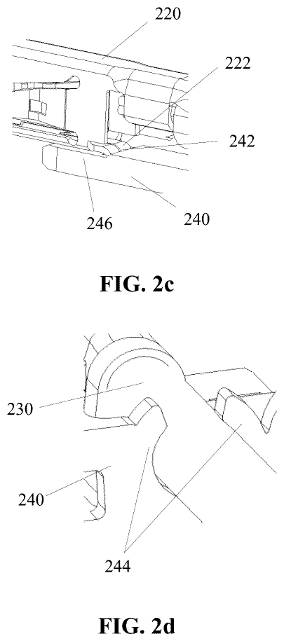

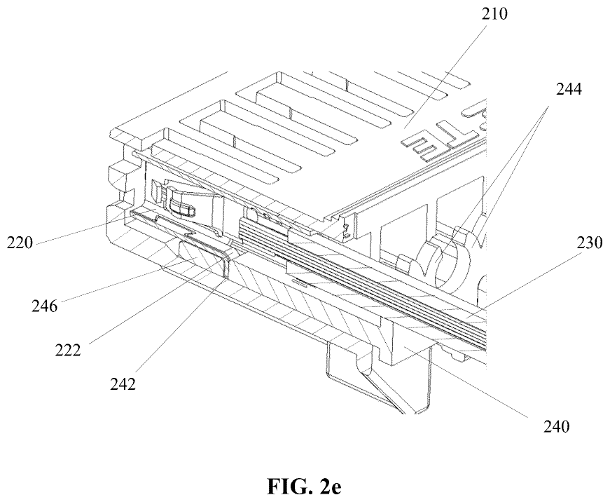

As shown in FIGS. 2a-2e, an embodiment of the present disclosure provides a schematic diagram of the assembly process and structure of a new type of electrical connector 200. FIG. 2a is a schematic diagram of the electrical connector 200 in a stage before the terminal is mounted to the housing. FIG. 2b is a schematic diagram of an assembly process of the electrical connector 200. FIG. 2c is an enlarged schematic diagram of an area E in FIG. 2b. FIG. 2d is an enlarged schematic diagram of an area F in FIG. 2b. And FIG. 2e is a schematic diagram of an internal structure of the electrical connector 200 after assembly.

As shown in FIGS. 2a-2e, the electrical connector 200 includes a housing 210, a terminal 220, a cable 230, and a terminal position assurance member 240. One end of the terminal 220 is connected to the cable 230, and the other end of the terminal 220 is inserted into the housing 210 to be electrically connected to other external electrical components, thereby realizing transmission of electrical signals at two ends of the electrical connection. In some examples, the terminal position assurance member 240 includes a terminal fixing portion 242. The terminal fixing portion 242 is configured to fixedly connect the terminal position assurance member 240 to the terminal 220, and after the terminal 220 is fixedly connected to the terminal position assurance member 240, the terminal 220 may be mounted to the housing 210 together with the terminal position assurance member 240. In some examples, the cable is a circular cable, one end of the terminal may be an annular structure, and the cable is inserted into the annular structure and a conductive portion of the cable is in contact with an inner wall of the annular structure to realize the electrically connection between the cable and the terminal.

In some examples, in the process of mounting the terminal position assurance member 240 to the housing 210 by clamping, because the terminal 220 is fixedly connected to the terminal position assurance member 240, the terminal position assurance member 240 can drive the terminal 220 to move together, enabling the terminal 220 and the terminal position assurance member 240 to reach their respective mounting positions of the housing 210 synchronously. The fixed position of the terminal 220 in the housing may be achieved by fixing the terminal position assurance member 240 to the housing 210. The terminal fixing portion 242 can not only fix the terminal during assembly (for example, fix connection between the terminal and the terminal position assurance member and fixed position of the terminal in the housing), but also provide a holding force for the terminal when the corresponding plug-in component of the connector is inserted (for example, when the terminal is subjected to a force of the corresponding plug-in component in a certain direction, the terminal position assurance member may apply an opposite force via the terminal fixing portion), so that the terminal is fixed at a preset position, thereby ensuring the electrical connection performance of the electrical connector.

In some examples, the cable 230 may be mounted to the terminal position assurance member 240 together with the terminal 220, and then the cable 230 and the terminal 220 may be mounted to the housing 210 together with the terminal position assurance member 240. Specifically, firstly, the cable 230 is electrically connected to one end of the terminal 220. Secondly, the terminal 220 is mounted to the terminal position assurance member 240, and the terminal 220 drives the cable 230 to be mounted to the preset position of the terminal position assurance member 240 together in the mounting process. Finally, the terminal position assurance member 240 is mounted to the housing 210, and the terminal position assurance member 240 drives the terminal 220 and the cable 230 to be mounted to the preset position of the housing 210 together in the mounting process. In some examples, there is a fixed connection structure between the cable 230 and the terminal position assurance member 240, independent of the terminal fixing portion, and the cable 230 is actually driven by the terminal position assurance member 240 to enter the preset position of the housing 210. In some other examples, there is no fixed connection structure between the cable 230 and the terminal position assurance member 240 independent of the terminal fixing portion, and the cable 230 is actually driven by the terminal position assurance member 240 via the terminal 220 to enter the preset position of the housing 210.

In some examples, the terminal fixing portion 242 is an insertion hole. Correspondingly, the terminal 220 includes an insertion portion 222 extending outward. The insertion portion 222 may be pressed and inserted into the insertion hole 242, thereby fixing the terminal 220 to the terminal position assurance member 240, as shown in FIG. 2c. In some examples, the insertion portion 222 of the terminal 220 is a sheet-like structure. In some examples, the insertion portion 222 of the terminal 220 is formed by bending two sides of the material inward to in contact with each other and then bending downward. In some other examples, the insertion portion 222 of the terminal 220 may be formed by bending only a single side of the material downward.

In some other examples, the structures of the insertion portion 222 of the terminal 220 and the terminal fixing portion 242 of the terminal position assurance member 240 may be interchanged, that is, the terminal 220 is provided with an insertion hole, and the terminal position assurance member 242 is provided with an insertion portion extending outward. In an embodiment, the terminal fixing portion 242 is provided with the insertion hole, which is beneficial to maximize the conductive material of the terminal 220 and improve the mechanical performance and current-carrying performance of the product. In addition, the terminal 220 of the improved electrical connector 200 does not require a limiting groove to be fixedly connected to the housing 210, so that the terminal 220 may have a complete plane, allowing the conductive material of the terminal 220 to increase, and improving the mechanical performance and the current-carrying performance of the product. In some examples, the housing 210 has no limiting structure for the terminal 220 inside the housing 210, so that the housing structure is simplified and the production process is simplified.

Optionally, the insertion portion 222 may be disposed at the bottom of the terminal 220, or may be disposed at the top or side of the terminal 220. Correspondingly, the position of the terminal fixing portion 242 of the terminal position assurance member 240 also needs to be adjusted accordingly. In some examples, a plurality of terminal fixing portions 242 may be disposed on the terminal position assurance member 240, and the plurality of terminal fixing portions 242 are used to fix a single terminal 220. In some other examples, a plurality of terminal fixing portions 242 may be disposed on the terminal position assurance member 240, and the plurality of terminal fixing portions 242 are used to fix a plurality of terminals 220 respectively.

In some examples, the terminal position assurance member 240 further includes a cable fixing portion 244, as shown in FIG. 2d. The cable fixing portion 244 is used to fix the cable 230, and the cable fixed by the cable fixing portion 244 is not easily deformed and shifted in position during assembly. Optionally, the cable fixing portion 244 may be disposed at a front end, a rear end, a side wall, or the like of the terminal position assurance member 240, and may be specifically adjusted based on the position of the cable. In some examples, a plurality of cable fixing portions 244 may be disposed on the terminal position assurance member 240, and the plurality of cable fixing portions 244 are configured to fix a single cable 230. In some other examples, a plurality of cable fixing portions 244 may be disposed on the terminal position assurance member 240, and the plurality of cable fixing portions 244 are configured to fix a plurality of cables 230 respectively.

In some examples, the cable fixing portion 244 is an elastic opening portion. By placing the cable on the opening side of the elastic opening portion 244 and then pressing the cable 230 to expand the opening of the elastic opening portion 244, the cable 230 may enter the interior of the elastic opening portion 244, and then the opening of the elastic opening portion 244 is elastically restored to the original size, so that the cable 230 is fixed inside the elastic opening portion 244, that is, the cable 230 is fixed on the terminal position assurance member 240. In some examples, the cable 230 is a circular cable, and the elastic opening portion 244 has an annular structure with an opening size smaller than the diameter of the cable. In some examples, the cable 230 is a rectangular cable, and the opening size of the elastic opening portion is smaller than a width of the cable.

In some examples, the terminal fixing portion 242 is an insertion hole, the cable fixing portion 244 is an elastic opening portion, and the opening direction of the terminal fixing portion 242 is consistent with or parallel to the opening direction of the cable fixing portion 244, so that the terminal 220 and the cable 230 can be fixed by one pressing operation (for example, pressing left, pressing right, pressing down, pressing up, or pressing obliquely, etc.), that is, the terminal 220 and the cable 230 are respectively fixedly connected to the terminal position assurance member 240. In this example, it simplifies assembly process and improves production efficiency. In some examples, the opening direction of the terminal fixing portion 242 and the opening direction of the cable fixing portion 244 are both upward, so that the cable and the terminal can be fixed by pressing the cable and the terminal downward, the downward pressing design facilitates the force application operation, and make the assembly more convenient.

In some examples, the terminal position assurance member 240 further includes a terminal supporting portion 246, as shown in FIGS. 2c and 2e. The terminal supporting portion 246 provides an upward supporting force to the terminal 220. The terminal supporting portion 246 may be disposed corresponding to the position of the center of gravity of the terminal or the terminal and the cable. In some examples, the terminal supporting portion 246 may be designed to be one-half the terminal length. In some examples, the terminal supporting portion 246 is disposed at the front end of the terminal fixing portion 242. In some examples, the top surface of the terminal supporting portion 246 is in contact with the bottom surface of the terminal 220 and are horizontally disposed.

The electrical connector 200 of the present disclosure may implement the assembly process by clamping the terminal 220. The terminal 220 and the cable 230 may be driven to enter the housing 210 by the terminal position assurance member 240, which can avoid cable deformation in the assembly process.

In some examples, the terminal position assurance member 240 has an integrally formed structure. The design of the integrally formed structure of the terminal position assurance member 240 has significant advantages in terms of improving product production efficiency, enhancing product structural strength, improving product appearance, and simplifying maintenance.

In some examples, the assembly process of the electrical connector 200 may be described as follows: firstly, the cable 230 and the terminal 220 (one end of the terminal is electrically connected to the cable) are placed above the terminal position assurance member 240 by clamping the terminal 220; secondly, the cable 230 and the terminal 220 are pressed so that the cable 230 and the terminal 220 are fixed to the terminal position assurance member 240 via the cable fixing portion 244 and the terminal fixing portion 242 respectively; finally, the terminal position assurance member 240 is operated to be connected to the housing 210, meanwhile, the cable 230 and the terminal 200 are driven by the terminal position assurance member 240, mounted to the housing 210 together with the terminal position assurance member 240.

It is easy to realize automation of the above assembly process, which can greatly improve the production and manufacturing efficiency of the electrical connector 200 and reduce the production and manufacturing cost. Moreover, the force applying object in the assembly process does not include the cable, which can effectively alleviate the problem that the cable is easily deformed in the prior art. Accordingly, the present disclosure is particularly applicable to electrical connectors with small wire diameter cables.

By providing the terminal position assurance member with a terminal fixing portion, it enables the terminal to be mounted to the housing together with the terminal position assurance member after being fixedly connected with the terminal position assurance member. By optimizing the structural design of the new type of electrical connector, the assembly process of the electrical connector is effectively optimized and the deformation issue of the small wire diameter cable in the assembly process is alleviated, so as to meet the requirements of automatic assembly devices, facilitate automatic assembly, reduce the production cost of products, and improve the production efficiency of products.

The electrical connector provided by the present disclosure has a novel structure and assembly manner. By providing the terminal position assurance member with the terminal fixing portion, it enables the terminal to be firstly fixed on the terminal position assurance member, and subsequently to be mounted to the housing together with the terminal position assurance member when the terminal position assurance member is mounted to the housing. The electrical connector provided by the present disclosure has the advantages of facilitating automatic assembly and making cables not easily deformed during the assembly process.

It should be noted that the above examples are only embodiments of the present disclosure and the present disclosure is not limited to the above examples. All variations directly derived or associated from the contents of the present disclosure by those skilled in the art shall fall within the protection scope of the present disclosure.

Although the embodiments of the present disclosure have been described with reference to several specific examples, it should be understood that the embodiments of the present disclosure are not limited to the disclosed specific embodiments. The embodiments of the present disclosure are intended to cover various modifications and equivalent arrangements included within the spirit and scope of the appended claims. The scope of the appended claims is to be accorded the broadest interpretation so as to encompass all such modifications and equivalent structures and functions.

1. An electrical connector, comprising:
a terminal having an end connecting to a cable;
a terminal position assurance member having a terminal fixing portion fixedly connecting to the terminal; and
a housing, the terminal is mounted to the housing together with the terminal position assurance member.

2. The electrical connector of claim 1, wherein the terminal fixing portion is an insertion hole.

3. The electrical connector of claim 2, wherein the terminal has an insertion portion extending outward.

4. The electrical connector of claim 3, wherein then insertion portion is pressed and inserted into the insertion hole to fix the terminal to the terminal position assurance member.

5. The electrical connector of claim 1, wherein the terminal position assurance member has a cable fixing portion fixing the cable.

6. The electrical connector of claim 5, wherein the cable fixing portion is an elastic opening portion.

7. The electrical connector of claim 6, wherein the cable is pressed to expand an opening of the elastic opening portion and allow the cable to enter an interior of the elastic opening portion.

8. The electrical connector of claim 2, wherein the cable fixing portion is an elastic opening portion.

9. The electrical connector of claim 8, wherein an opening direction of the terminal fixing portion is parallel to an opening direction of the cable fixing portion.

10. The electrical connector of claim 9, wherein the opening direction of the terminal fixing portion and the opening direction of the cable fixing portion are both upward.

11. The electrical connector of claim 1, wherein the terminal position assurance member has a terminal supporting portion providing an upward supporting force to the terminal.

12. The electrical connector of claim 1, wherein the terminal position assurance member has an integrally formed structure.

13. The electrical connector of claim 12, wherein the terminal fixing portion is one of a plurality of terminal fixing portions of the terminal position assurance member and the terminal is one of a plurality of terminals of the electrical connector, each of the terminal fixing portions fixes one of the terminals.

14. The electrical connector of claim 1, wherein the housing has no limiting structure for the terminal inside the housing.

15. The electrical connector of claim 1, wherein the cable is mounted to the terminal position assurance member together with the terminal.
